(19) United States
(12) Patent Application Publication
(10) Pub. No.: US 2011/0152027 A1
(43) Pub. Date: Jun. 23, 2011

(54) ELECTRONIC BOOSTER AND OPERATING FORCE TRANSMISSION DEVICE

(76) Inventors: Takayuki Ohno, Yokohama-shi (JP); Naoki Shirakawa, Kofu-shi (JP); Yukio Ohtani, Kawasaki-shi (JP); Takuya Usui, Yokohama-shi (JP)

(21) Appl. No.: 12/892,325

(22) Filed: Sep. 28, 2010

(30) Foreign Application Priority Data
Oct. 30, 2009 (JP) 250929/2009

(51) Int. Cl. F16H 48/06; F16H 25/08

(52) U.S. Cl. 475/150; 74/25

(57) ABSTRACT

In an electric booster according to one embodiment of the present invention, a brake pedal is connected to a sun gear of a differential transmission mechanism corresponding to a planetary gear mechanism. An electric motor is connected to a ring gear, and an output rod is connected to a planetary carrier, and the output rod is connected to a piston of a master cylinder. When the brake pedal is operated to rotate the sun gear, planetary pinions rotate and revolve around the sun gear. As a result, the planetary carrier rotates to move the output rod forward to push the piston. As a result, a hydraulic pressure is generated in the master cylinder. At this time, the electric motor is controlled according to the rotation of the sun gear to rotate the ring gear so that the ring gear follows the sun gear. In this manner, a servo force of the electric motor is applied to the rotation of the planetary carrier.

### BACKGROUND OF THE INVENTION

The present invention relates to an electric booster and an operating force transmission device.

As a booster used for an automobile brake system, there is known an electric booster using an electric motor as a boost source as described in, for example, Japanese Patent Application Laid-open No. 2007-191133. The electric booster drives the electric motor according to movement of an input piston moving in conjunction with an operation of a brake pedal, to thereby thrust a piston of a master cylinder through an intermediation of a ball screw (rotary-to-linear motion converting mechanism). In this manner, the electric booster generates a desired hydraulic pressure and supplies the generated hydraulic pressure to a brake caliper for each wheel. At this time, the hydraulic pressure in the master cylinder is partially received by the input piston which passes through the piston to be inserted into a pressure chamber of the master cylinder. In this manner, a reaction force generated at the time of braking is partially fed back to the brake pedal.

However, the electric booster described in Japanese Patent Application Laid-open No. 2007-191133 cited above has a structure in which the hydraulic pressure in the master cylinder is directly received by the input piston, and therefore, is difficult to be separated from the master cylinder. Hence, the electric booster has a problem of a low degree of freedom in design.

### SUMMARY OF THE INVENTION

The present invention has an object to provide an electric booster which is structurally easy to be separated from a master cylinder.

In order to achieve the above-mentioned objects, an electric booster according to the present invention includes: an electric motor; a differential transmission mechanism including: a first input shaft connected to a brake pedal; a second input shaft to which the electric motor is connected; and an output shaft for outputting a turning force obtained by combining a turning force of the first input shaft and a turning force of the second input shaft, the first input shaft, the second input shaft, and the output shaft making differential motions with respect to each other; and an output mechanism for converting rotation of the output shaft into linear movement to thrust a piston of a master cylinder.

### BRIEF DESCRIPTION OF THE DRAWINGS

In the accompanying drawings:

FIG. 1 is a longitudinal sectional view of a right side surface of an electric booster according to a first embodiment;

FIG. 2 is a longitudinal sectional view of a left side surface of the electric booster illustrated in FIG. 1;

FIG. 3 is a longitudinal sectional view of a front surface of the electric booster illustrated in FIG. 1;

FIG. 4 is a longitudinal sectional view illustrating a differential transmission mechanism corresponding to a principal part of the electric booster illustrated in FIG. 1;

FIG. 5 is a transverse sectional view illustrating the differential transmission mechanism corresponding to the principal part of the electric booster illustrated in FIG. 1;

FIG. 6 is a graph showing input/output displacement characteristics of the electric booster illustrated in FIG. 1;

FIG. 7 is a transverse sectional view illustrating a differential transmission mechanism corresponding to a principal part of an electric booster according to a second embodiment;

FIG. 8 is a side view of an electric booster according to a third embodiment;

FIG. 9 is a front view of the electric booster illustrated in FIG. 8;

FIG. 10 is a longitudinal sectional view of the electric booster illustrated in FIG. 8;

FIG. 11 is a block diagram illustrating a schematic configuration of the electric booster;

FIG. 12 is a perspective view illustrating a schematic configuration of an electric power steering device for vehicle when an electric assist mechanism illustrated in FIG. 10 is used for the electric power steering device for vehicle; and

FIG. 13 is a longitudinal sectional view of the electric assist mechanism incorporated into the power steering device illustrated in FIG. 12.

### DETAILED DESCRIPTION OF THE INVENTION

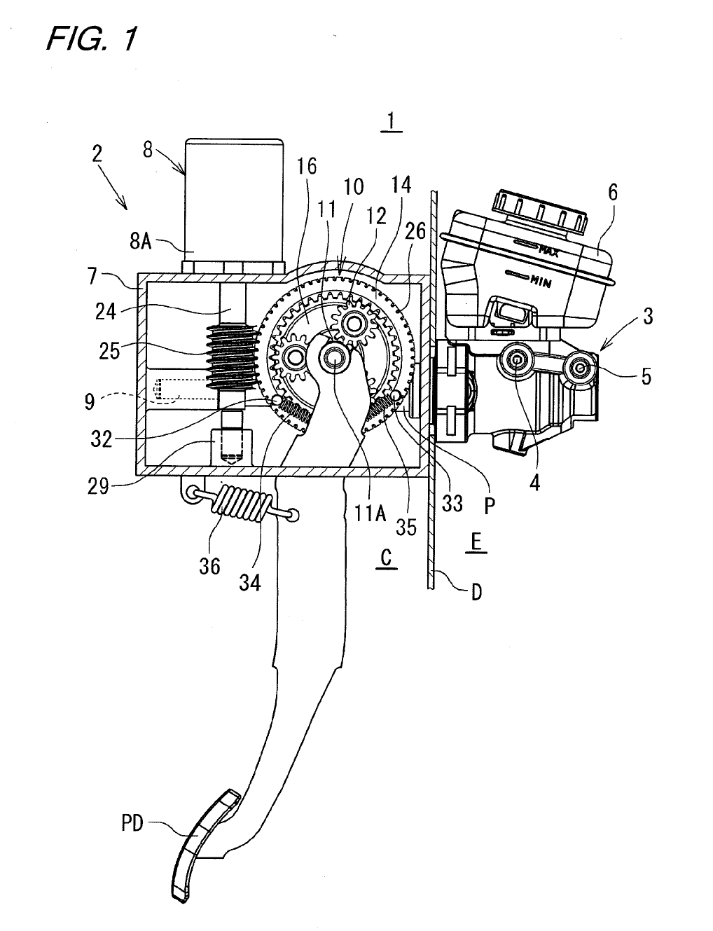

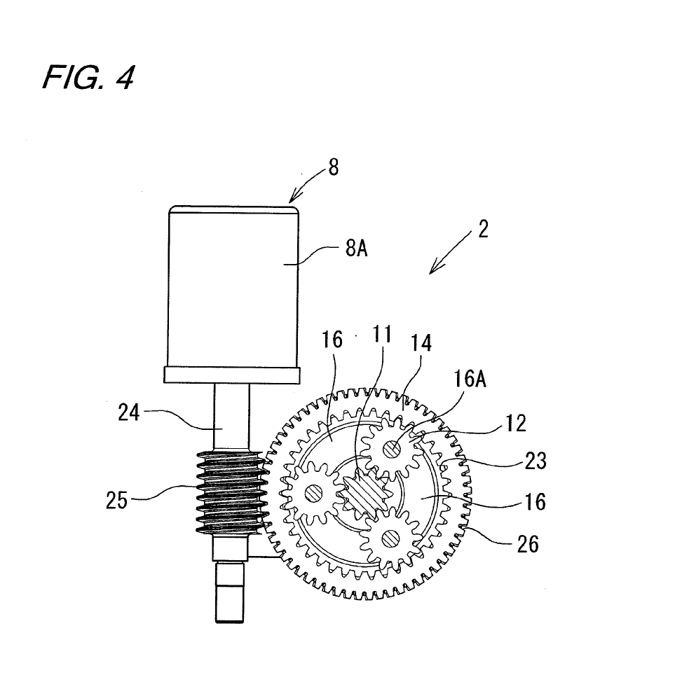

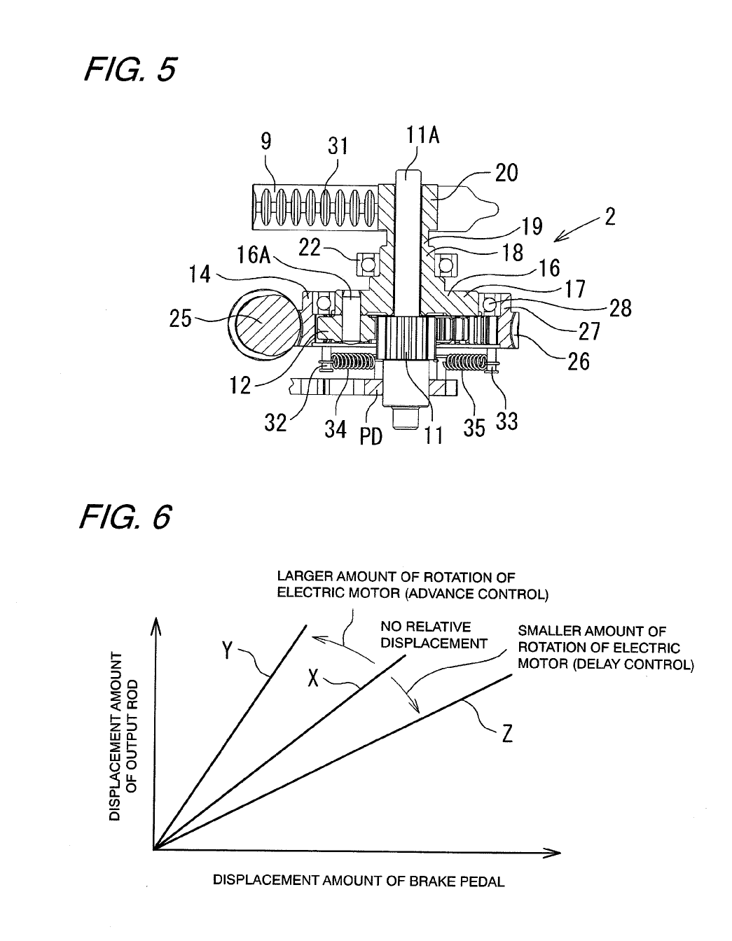

Hereinafter, embodiments of the present invention are described in detail based on the drawings. An electric booster 1 according to a first embodiment is described referring to FIGS. 1 to 6. The electric booster 1 according to the first embodiment is mounted to an automobile brake system. As illustrated in FIGS. 1 to 3, the electric booster 1 includes an electric assist mechanism 2 mounted to a dash panel D on a cabin C side. The dash panel D corresponds to a partition wall between an engine room E and the cabin C. The electric assist mechanism 2 is connected to a brake pedal PD and is also connected to a master cylinder 3 mounted to the engine room E side with the dash panel D interposed therebetween.

The master cylinder 3 is the same as a tandem master cylinder used for a hydraulic brake system for general automobiles. By forward movement of a piston P, the master cylinder 3 supplies a hydraulic pressure from a primary port 4 and a secondary port 5 to a brake caliper for each wheel or the like (not shown) through an intermediation of a dual-system hydraulic circuit. As a result, a braking force is generated. When the piston P is moved backward, the master cylinder 3 replenishes a brake fluid from a reservoir 6 as needed.

The electric assist mechanism 2 includes an electric motor 8 and a differential transmission mechanism 10. The electric motor 8 is provided on the outer side of a case 7 mounted to the dash panel D. The differential transmission mechanism 10 is housed in the case 7. The electric assist mechanism 2 is configured to receive an operation of the brake pedal PD as a rotational input so as to output a boosted force to an output rod 9 which is connected to the piston P of the master cylinder 3.

The differential transmission mechanism 10 is a planetary gear mechanism in this embodiment. The differential transmission mechanism 10 includes a sun gear 11, three planetary pinions 12, a planetary carrier 16, and a ring gear 14. The sun gear 11 is provided in the center and serves as a first input shaft connected to the brake pedal PD. The planetary pinions 12 are provided around the sun gear 11 so as to be meshed therewith. The planetary carrier 16 rotatably supports the planetary pinions 12 and serves as an output shaft. The ring gear 14 is provided around the three planetary pinions 12 so as to be meshed therewith and serves as a second input shaft. The center of rotation of the sun gear 11, that of the planetary carrier 16, and that of the ring gear 14 are concentrically located.

The sun gear 11 has a shaft portion 11A. Both ends of the shaft portion 11A are rotatably supported by bearing portions 13 which are formed on the case 7. A base portion of the brake pedal PD is fixed to one end side of the shaft portion 11A, whereas the other end of the shaft portion 11A passes through a corresponding one of the bearing portions 13 to externally extend from the case 7. A rotational position sensor 15 for detecting a rotational position of the sun gear 11 is provided to a distal end portion of the other end of the shaft 11A.

In the first embodiment, the base portion of the brake pedal PD is directly fixed to be connected to the one end side of the shaft portion 11A. However, other connection structures may be used as long as turning movement of the brake pedal PD is transmitted to the one end side of the shaft portion 11A. For example, the following connection structure may be used. A rotary joint is provided between the one end of the shaft portion 11A and the brake pedal PD so as to enable the rotation of the one end of the shaft portion 11A and the rotation of the base portion of the brake pedal PD relative to each other. In addition, an abutment portion, which comes into abutment against any one of the rotary joint and the one end side of the shaft portion 11A in a direction in which the brake pedal PD is pressed, is provided between the one end of the rotary joint or the shaft portion 11A and the base portion of the brake pedal PD so that the shaft portion 11A follows the turning movement of the brake pedal PD. On the other hand, when the shaft portion 11A is turned by the electric motor 8 while the brake pedal PD is not operated, an abutting area of the abutment portion is separated to allow the shaft portion 11A alone to be turned. In the case where the connection structure described above is used, the brake pedal PD is not moved even if the electric motor 8 is driven at the time of vehicle stability control, adaptive cruise control, or automatic brake control, each corresponding to brake control performed without operating the brake pedal PD. Therefore, a driver is not bothered by an uncomfortable feeling.

The three planetary pinions 12 are rotatably supported respectively by three planetary shafts 16A fixed to the planetary carrier 16 provided on the side of the sun gear 11, which is opposite to the side where the brake pedal PD is fixed. The planetary carrier 16 includes a large-diameter portion 17, a small-diameter portion 18, a hollow shaft portion 19, and a pinion portion 20, which are concentrically formed in an integrated manner. The planetary shafts 16A are fixed to the large-diameter portion 17. The small-diameter portion 18 is adjacent to the large-diameter portion 17. The hollow shaft portion 19 projects from the small-diameter portion 18. The pinion portion 20 is formed at a distal end portion of the hollow shaft portion 19. The small-diameter portion 18 of the planetary carrier 16 is rotatably supported on a bearing portion 21 of the case 7 by a bearing 22. The shaft portion 11A of the sun gear 11 is rotatably inserted through the hollow shaft portion 19.

Internal teeth 23, which are meshed with the three planetary pinions 12, are formed on an inner circumference of the ring gear 14. On an outer circumference of the ring gear 14, external teeth 26 which are meshed with a worm gear 25 mounted to a shaft 24 of the electric motor 8 are formed. Further, a cylindrical portion 27 formed on a side portion of the ring gear 14 is rotatably supported on the large-diameter portion 17 of the planetary carrier 16 by a bearing 28.

The shaft 24 extending from a case portion 8A is provided to the electric motor 8. The case portion 8A is mounted to the outer side of the case 7. The shaft 24 passes through a wall of the case 7 to be extended to the inside of the case 7. As a result, the worm gear 25 mounted to the shaft 24 is meshed with the external teeth 26 of the ring gear 14. In this embodiment, the worm gear 25 and the external teeth 26 of the ring gear 14 constitute a reduction mechanism. A distal end portion of the shaft 24 is rotatably supported by a bearing portion 29 formed on the case 7.

One end of the output rod 9 is inserted into the master cylinder 3, to thereby abut against the piston P of the master cylinder 3 so as to be connected thereto. The other end of the output rod 9 is slidably inserted into a guide portion 30 formed on the case 7. In this manner, the output rod 9 is guided so as to be able to move forward and backward along an axial direction of the master cylinder 3. On an axially intermediate portion of the output rod 9, a rack portion 31 which is meshed with the pinion portion 20 of the planetary carrier 16 is formed. A rotary-to-linear motion converting mechanism including the pinion portion 20 and the rack portion 31 constitutes an output mechanism in this embodiment. In the case where a rack area is directly formed on the piston P itself, the pinion portion 20, which is meshed with the rack area, constitutes the output mechanism. As described above, the pinion portion 20 and the rack portion 31 are used as the rotary-to-linear motion converting mechanism in the first embodiment. Therefore, a ball screw, which is used in the electric booster described in Japanese Patent Application Laid-open No. 2007-191133, is not required to be used. Accordingly, the number of components and cost can be reduced. In addition, it is easy to replenish a grease to improve ease of maintenance.

A pair of locking portions 32 and 33 are mounted to the ring gear 14. A pair of offset springs 34 and 35 (urging means; first spring means and second spring means) are provided. The offset spring 34 is provided between the locking portion 32 and the brake pedal PD which turns together with the sun gear 11, whereas the offset spring 35 is provided between the locking portion 33 and the brake pedal PD. The offset spring 34 applies a spring force so that the brake pedal PD, that is, the sun gear 11 and the ring gear 14 rotate relative to each other in one direction, whereas the offset spring 35 applies the spring force so that the sun gear 11 and the ring gear 14 rotate relative to each other in the opposite direction. In this manner, the offset springs 34 and 35 elastically maintain the sun gear 11 and the ring gear 14 in neutral positions as illustrated in FIG. 1.

Any one of the offset springs 34 and 35 may be omitted so that the sun gear 11 and the ring gear 14 are elastically maintained in predetermined positions by a single return spring. Moreover, in this embodiment, the brake pedal PD, which turns in the same manner as the sun gear 11 constituting the first input shaft does, is regarded as a part of the first input shaft. Between the brake pedal PD and the ring gear 14 constituting the second input shaft, the pair of offset springs 34 and 35 constituting the urging means are provided. However, the structure in which the pair of offset springs 34 and 35 are provided is not limited thereto. The pair of offset springs 34 and 35 may be provided between the sun gear 11 and the ring gear 14. Alternatively, the pair of offset springs 34 and 35 may be provided between the planetary carrier 16 constituting the output shaft and the sun gear 11 or between the planetary carrier 16 and the brake pedal PD.

A return spring 36 for biasing the brake pedal PD to place the brake pedal PD in a non-braking position illustrated in FIG. 1 is provided between the brake pedal PD and the case 7.

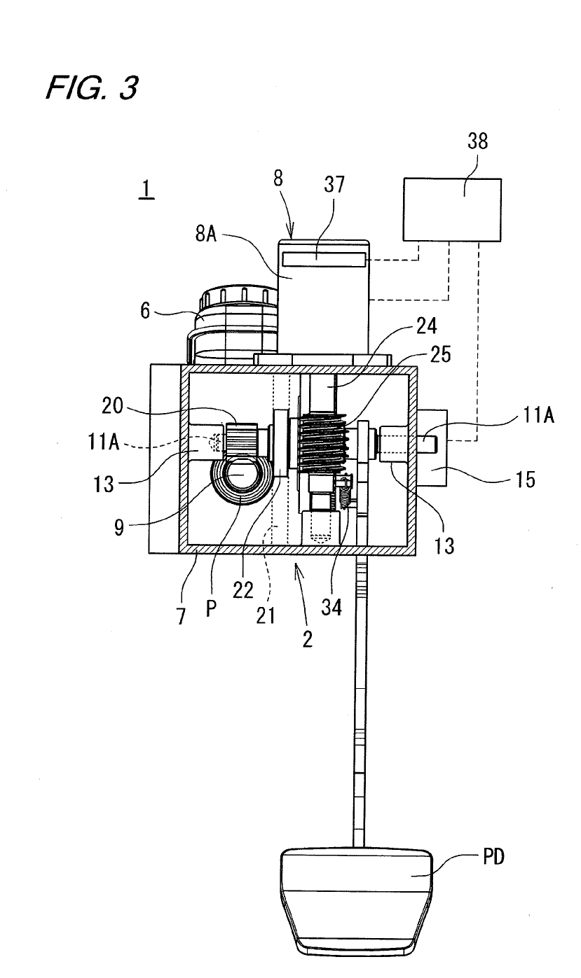

As illustrated in FIG. 3, besides the rotational position sensor 15, a motor rotational position sensor 37 for detecting a rotational position of the shaft 24 of the electric motor 8 is provided to the electric booster 1. Further, a controller 38 is provided to the electric booster 1. The controller 38 controls the rotation of the electric motor 8 based on detection signals from the rotational position sensor 15, the motor rotational position sensor 37, and various sensors for detecting other necessary state quantities (for example, a master cylinder pressure and the like) and signals from an ECU of a vehicle attitude control system and an ECU of a vehicle control system.

The functions of the electric booster 1 of this embodiment, which is configured as described above, are now described.

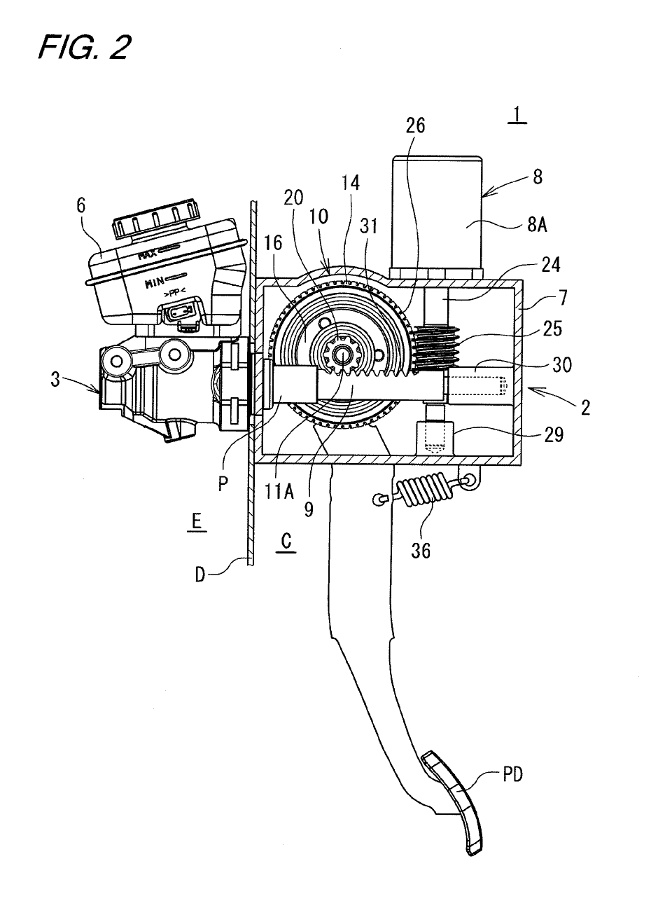

The sun gear 11 is rotated by the operation of the brake pedal PD (operation from the left to the right in FIG. 1 and from the right to the left in FIG. 2), which is performed by the driver for braking. By the rotation of the sun gear 11, the planetary pinions 12 revolve around the sun gear 11 while rotating. With the revolution of the planetary pinions 12 around the sun gear 11, the planetary carrier 16 rotates. With the rotation of the planetary carrier 16, the output rod 9 is moved forward by the meshing engagement between the pinion portion 20 and the rack portion 31 of the output rod 9. In this manner, the piston P is pushed by the output rod 9 to generate a hydraulic pressure in the master cylinder 3. Then, the hydraulic pressure in the master cylinder 3 is supplied to the brake caliper for each wheel or the like through an intermediation of the hydraulic circuit. As a result, the braking force is generated.

At this time, the controller 38 detects the rotation of the sun gear 11 by the rotational position sensor 15 as the amount of operation of the brake pedal PD. According to the rotational position of the sun gear 11, the controller 38 controls the electric motor 8, to thereby rotate the shaft 24 so that the amount of rotation of the sun gear 11 and that of the ring gear 14 become equal to each other. By the rotation of the shaft 24, the ring gear 14 rotates at a constant reduction ratio through the meshing engagement between the worm gear 25 and the external teeth 26 of the ring gear 14. At this time, an angle of rotation of the sun gear 11 and that of the ring gear 14 become equal to each other. Thus, control with no relative displacement is performed. Then, the planetary pinions 12 are made to revolve around the sun gear 11 while rotating. The planetary carrier 16 is rotated, and the rotation of the planetary carrier 16 follows the rotation of the sun gear 11 which is caused by the operation of the brake pedal PD. As a result, a turning force of the planetary carrier 16, which is obtained by the operation of the brake pedal PD, is combined with a turning force of the shaft 24 of the electric motor 8 to thrust the output rod 9. At this time, the relation between an input displacement amount corresponding to a displacement amount of the brake pedal PD and an output displacement amount corresponding to a displacement amount of the output rod 9 is a characteristic indicated by a line X shown in FIG. 6.

When the output rod 9 is thrust as described above, a reaction force is exerted from the piston P of the master cylinder 3 on the planetary carrier 16 through the output rod 9. The reaction force is distributed to the ring gear 14 and the sun gear 11 at a constant ratio based on the above-mentioned reduction ratio by the differential transmission mechanism 10 corresponding to the planetary gear mechanism. Therefore, a force for operating the brake pedal PD connected to the sun gear 11 is advantageously reduced. Specifically, the constant ratio based on the reduction ratio described above is a basic boost ratio in the electric booster 1 and the electric assist mechanism 2. In the differential transmission mechanism 10 of this embodiment, the sun gear 11, the ring gear 14, and the planetary carrier 16, which correspond to three input/output shafts of the planetary gear mechanism, make differential motions with respect to each other. A ratio of the turning force of the brake pedal PD connected to the sun gear 11 and that of the electric motor 8 connected to the ring gear 14 can be determined based on the reduction ratio of the planetary gear mechanism. It is preferred to determine the ratio of the turning force so that the turning force of the ring gear 14 is larger than that of the sun gear 11, that is, about 1:3 to 1:4. In this case, a pedal ratio based on the above-mentioned reduction ratio of the brake pedal PD of the first embodiment is 1:7 to 1:8.

As described above, in the first embodiment, the first input shaft connected to the brake pedal PD is constituted by the sun gear 11. The second input shaft, to which the electric motor is connected, is constituted by the ring gear 14. The output shaft for outputting the turning force obtained by combining the turning force of the first input shaft and the turning force of the second input shaft is constituted by the planetary carrier 16. As the relation between the sun gear 11, the ring gear 14, and the planetary carrier 16, which correspond to the three input/output shafts of the planetary gear mechanism, and the brake pedal PD, the electric motor 8, and the output rod 9, each corresponding to a connection element with the three input/output shafts, the above-mentioned relation allows a large reduction ratio to be obtained. However, the relation is not limited thereto. For example, the brake pedal PD may be connected to the planetary carrier 16 and the output rod 9 may be connected to the sun gear 11 although the reduction ratio is lowered. In this case, the planetary carrier 16 constitutes the first input shaft, whereas the sun gear 11 constitutes the output shaft.

The relation between the input displacement amount and the output displacement amount of the electric booster 1 and the electric assist mechanism 2 according to the first embodiment can be freely changed in addition to the case where the operation is performed with no relative displacement, that is, the amount of rotation of the ring gear 14 is made equal to the amount of rotation of the sun gear 11, which corresponds to the input displacement amount, as described above. Specifically, the displacement amount of the output rod 9 with respect to the displacement amount of the brake pedal PD can be changed. Referring to FIG. 6, the relation of the displacement amount of the output rod 9 (output displacement amount; the amount of rotation of the planetary carrier 16) with respect to the displacement amount of the brake pedal PD (input displacement amount; the amount of rotation of the sun gear 11) will be described. The displacement amount of the output rod 9 is proportional to the displacement amount of the brake pedal PD. A gradient of a line indicating the relation between the output displacement amount and the input displacement amount is determined by the amount of rotation of the output shaft 24 of the electric motor 8 (amount of rotation of the ring gear 14). As the amount of rotation of the electric motor 8 increases, the gradient becomes greater to result in a characteristic indicated by the line Y shown in FIG. 6. As the amount of rotation of the electric motor 8 decreases, the gradient becomes smaller to result in a characteristic indicated by a line Z shown in FIG. 6. As described above, so-called advance control for increasing the amount of rotation of the electric motor 8 with respect to the displacement amount of the brake pedal PD so as to increase the displacement amount of the output rod 9 is performed. As a result, pressure-increasing control is enabled. On the other hand, so-called delay control for reducing the amount of rotation of the electric motor 8 with respect to the displacement amount of the brake pedal PD so as to reduce the displacement amount of the output rod 9 is performed. As a result, pressure-reducing control in regenerative cooperative control is enabled.

The input/output characteristic (relation between pedal pressing force and brake hydraulic pressure) of the electric booster 1 and the electric assist mechanism 2 in the first embodiment is represented by the boost ratio based on the reduction ratio of the differential transmission mechanism 10 corresponding to the planetary gear mechanism. As described above, the basic boost ratio remains unchanged even in the case other than the operation with no relative displacement, that is, the amount of rotation of the ring gear 14 is made equal to the input displacement amount corresponding to the amount of rotation of the sun gear 11, because the reduction ratio of the differential transmission mechanism 10 is constant. When the advance control or the delay control for varying the displacement amount of the output rod 9 with respect to the displacement amount of the brake pedal PD as described above is performed, the position of the planetary carrier 16 following the sun gear 11 is changed with respect to the rotational position of the sun gear 11, which is caused by the operation of the brake pedal PD. As a result, a spring force of the offset springs 34 and 35 acting on the brake pedal PD is increased or reduced to change the input/output characteristic.

More specifically, for the advance control for performing brake assist control (line Y of FIG. 6), the displacement amount of the output rod 9 with respect to the displacement amount of the brake pedal PD becomes larger than for the control with no relative displacement (line X of FIG. 6). Therefore, the reaction force transmitted from the master cylinder 3 to the brake pedal PD increases with respect to the displacement amount of the brake pedal PD. However, the displacement amount of the output rod 9, that is, the amount of relative displacement between the amount of rotation of the ring gear 14 turned by the electric motor 8 and the displacement amount of the brake pedal PD becomes large (the amount of rotation of the ring gear 14 becomes larger than that of the sun gear 11). Thus, the offset spring 34 compresses and the offset spring 35 extends for the amount of relative displacement, to thereby generate a spring force in a direction of canceling the amount of increase in reaction force (force exerted in a direction in which the brake pedal PD is pressed; force exerted in a direction in which a pedal operating force is increased). In this manner, the reaction force with respect to the displacement amount of the brake pedal PD is adjusted.

Moreover, for the delay control for performing regenerative cooperative control (line Z of FIG. 6), the displacement amount of the output rod 9 with respect to the displacement amount of the brake pedal PD becomes smaller than for the control with no relative displacement (line X of FIG. 6). Therefore, the reaction force transmitted from the master cylinder 3 to the brake pedal PD decreases with respect to the displacement amount of the brake pedal PD. However, the displacement amount of the output rod 9, that is, the amount of relative displacement between the amount of rotation of the ring gear 14 turned by the electric motor 8 and the displacement amount of the brake pedal PD becomes small (the amount of rotation of the ring gear 14 becomes smaller than that of the sun gear 11). Thus, the offset spring 34 extends and the offset spring 35 compresses for the amount of relative displacement, to thereby generate a spring force in a direction of canceling the amount of decrease in reaction force (force exerted in a direction in which the brake pedal PD is released; force exerted in a direction in which a pedal operating force is decreased). In this manner, the reaction force with respect to the displacement amount of the brake pedal PD is adjusted.

As describe above, even when the input/output displacement characteristic of the electric booster 1 is changed, the reaction force against the operation of the brake pedal PD is adjusted by the offset springs 34 and 35. As a result, the input/output characteristic of the electric booster 1 remains unchanged. Therefore, the input/output displacement characteristic is changed to enable the brake control performed by the electric booster, such as the brake assist control, the regenerative cooperative control, and build-up control, without bothering the driver with an uncomfortable feeling due to the reaction force of the brake pedal. In this embodiment, the offset springs 34 and 35 constitute the urging means.

The above-mentioned offset springs 34 and 35 are not necessarily required to be provided. In addition, when the offset springs 34 and 35 are not provided, the control for the electric motor 8, which is performed by the controller 38, is not required to be limited to the above-mentioned control with no relative displacement. For example, based on the above-mentioned advance control as a standard, a stroke of the brake pedal PD may be shortened to improve a brake feel.

Moreover, when the shaft 24 of the electric motor 8 is prevented from rotating due to a failure of the electric motor 8, the controller 38, or the like, or lock-up between the worm gear 25 and the external teeth 26, the ring gear 14 is fixed by the meshing engagement between the worm gear 25 and the external teeth 26. Even in this state, however, by the operation of the brake pedal PD, the planetary pinions 12 revolve around the sun gear 11 while rotating so as to rotate the planetary carrier 16 at the constant reduction ratio. Therefore, by moving the output rod 9 forward, the braking force can be generated for the vehicle through an intermediation of the master cylinder 3 and the wheel cylinders. In this embodiment, a worm mechanism with a low backward efficiency is used as the reduction mechanism. Therefore, in case of failure of the electric motor 8, the operating force of the brake pedal PD can be transmitted to the output rod 9 without being released to the electric motor 8 side, that is, without any loss of the operating force.

As described above, in the electric booster 1 of the first embodiment, the reaction force from the piston P of the master cylinder 3 is distributed by the differential transmission mechanism 10. Therefore, it is not necessary to insert an input piston into a pressure chamber of the master cylinder for the distribution of the reaction force as in the case of the conventional electric boosters, and hence the separation of the electric booster 1 from the master cylinder 3 is facilitated. Thus, fabrication efficiency is improved because the electric booster 1 and the master cylinder 3 can be assembled separately. Further, it is not necessary to drain the brake fluid in the master cylinder 3 for the maintenance of the electric booster 1, to thereby provide ease of maintenance. Moreover, various types of brake control can be performed because the output displacement amount can be varied with respect to the input displacement amount. Further, in the electric assist mechanism 2 of the first embodiment, the output displacement amount can be varied with respect to the input displacement amount.

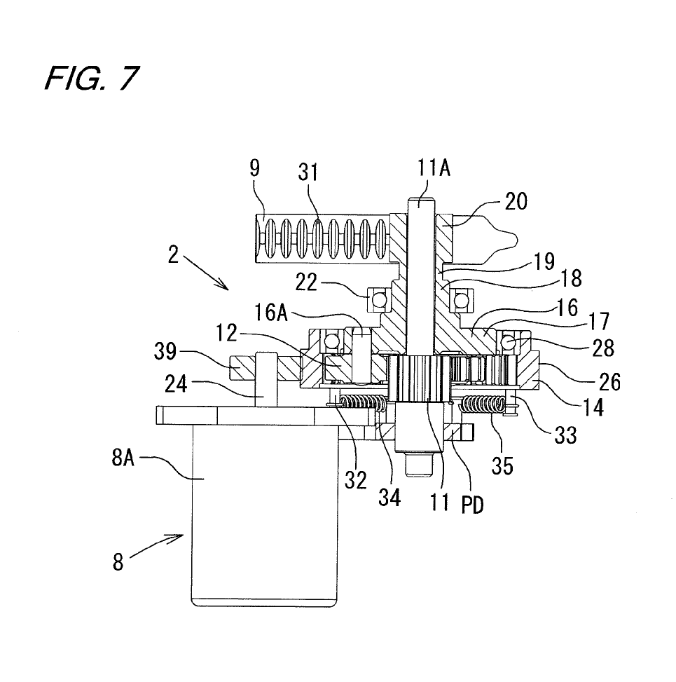

Next, a second embodiment is described referring to FIG. 7. The same parts as those of the first embodiment described above are denoted by the same reference symbols, and only different parts are described below in detail. As illustrated in FIG. 7, in place of the worm gear 25, a pinion 39 is mounted to the shaft 24 of the electric motor 8 in the second embodiment. The pinion 39 is meshed with the external teeth 26 of the ring gear 14. As a result, after the speed of the rotation of the electric motor 8 is reduced by the meshing engagement between the pinion 39 and the external teeth 26 of the ring gear 14, the driving force is transmitted to the ring gear 14. In the second embodiment, the pinion 39 and the external teeth 26 of the ring gear 14 constitute the reduction mechanism. As described above, by using the pinion 39 and the external teeth 26 of the ring gear 14, the electric motor 8 is arranged so that an axis of revolution of the differential transmission mechanism 10 and an axis of rotation of the electric motor 8 become parallel to each other. Therefore, dimensions of the electric booster 1 and the electric assist mechanism 2 in a gravity direction can be reduced as compared with those in the first embodiment. Thus, vehicle mountability is improved.

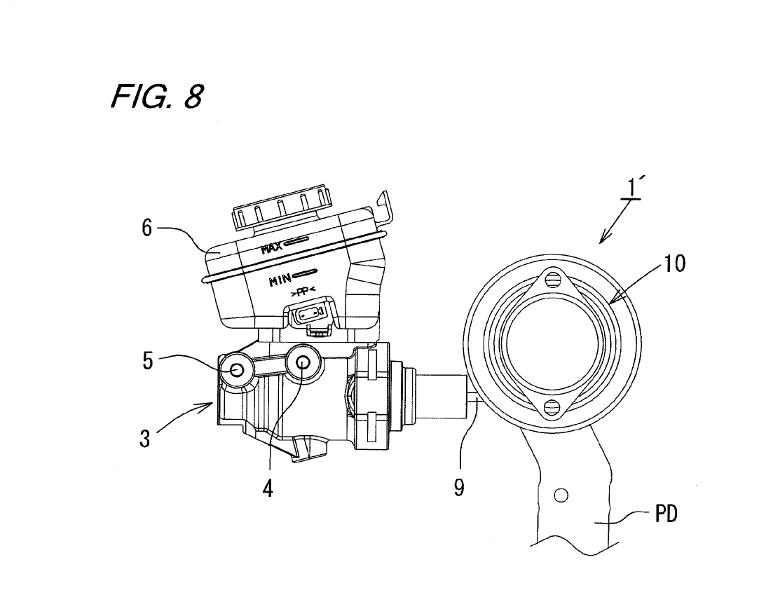

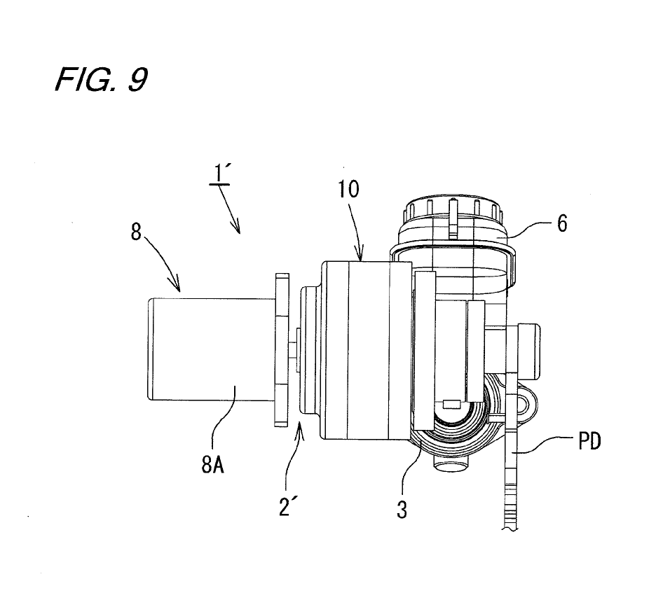

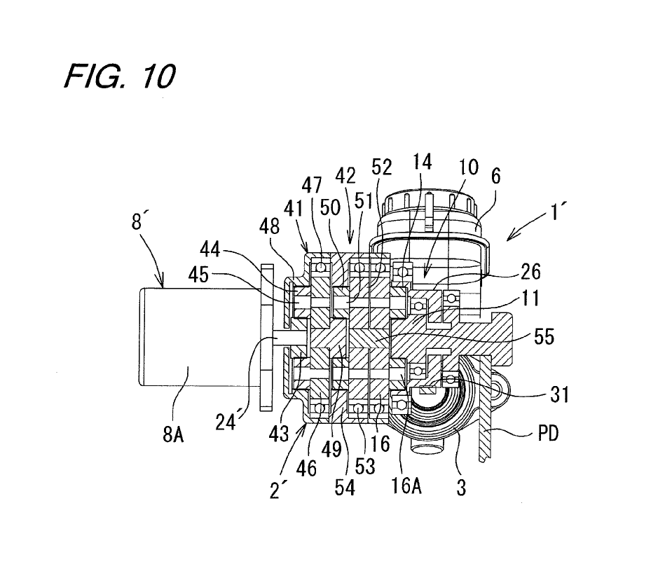

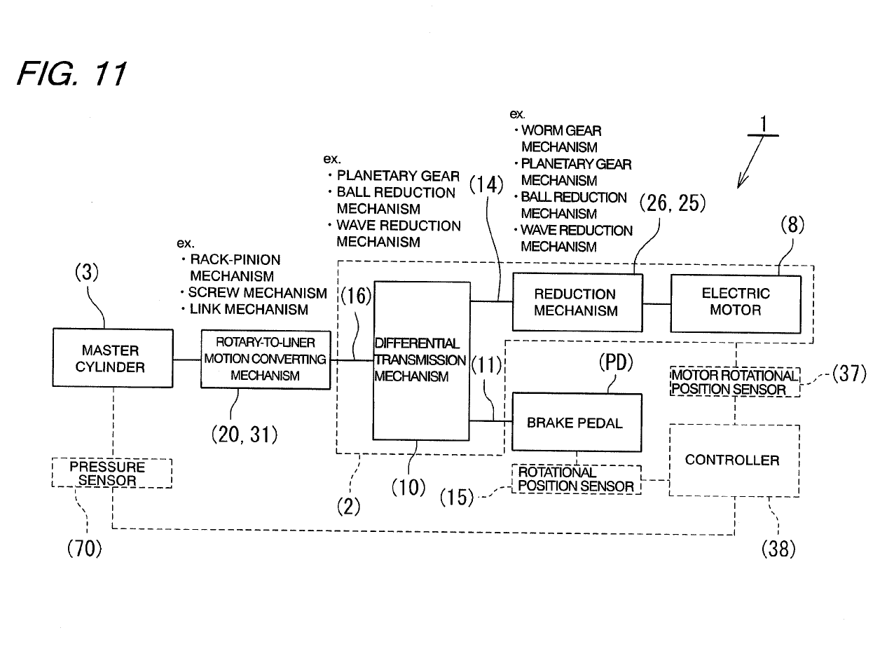

Next, a third embodiment is described referring to FIGS. 8 to 10. The same parts as those described in the first embodiment are denoted by the same reference symbols, and only different parts are described below in detail. As illustrated in FIGS. 8 to 10, in the differential transmission mechanism 10 of an electric booster 1′ and an electric assist mechanism 2′ according to this embodiment, the ring gear 14 serves as the output shaft and has the external teeth 26 which are meshed with the rack portion 31 of the output rod 9. The planetary carrier 16 serves as the second input shaft. The rotation of a shaft 24′ of an electric motor 8′ is transmitted to the planetary carrier 16 after the speed thereof is reduced in two stages through an intermediation of a first planetary gear reduction mechanism 41 and a second planetary gear reduction mechanism 42.

The first planetary gear reduction mechanism 41 includes a sun gear 43, a plurality of planetary pinions 44, a planetary carrier 46, and a ring gear 48. The sun gear 43 is mounted to the shaft 24′ of the electric motor 8′. The plurality of planetary pinions 44 are provided around the sun gear 43 so as to be meshed therewith. The planetary carrier 46 is rotatably provided so as to be adjacent to the sun gear 43 and the planetary pinions 44 to rotatably support the planetary pinions 44 with pinion shafts 45. The ring gear 48 is rotatably supported on an outer circumferential portion of the planetary carrier 46 by a bearing 47 and has internal teeth which are meshed with outer circumferential portions of the plurality of planetary pinions 44.

Further, the second planetary gear reduction mechanism 42 includes a sun gear 49, a plurality of planetary pinions 50, a planetary carrier 52, and a ring gear 54. The sun gear 49 is mounted to the planetary carrier 46 of the first planetary gear reduction mechanism 41. The plurality of planetary pinions 50 are provided around the sun gear 49 so as to be meshed therewith. The planetary carrier 52 is rotatably provided so as to be adjacent to the sun gear 49 and the planetary pinions 50 to rotatably support the planetary pinions 50 with pinion shafts 51. The ring gear 54 is rotatably supported on an outer circumferential portion of the planetary carrier 52 by a bearing 53 and has internal teeth which are meshed with outer circumferential portions of the plurality of planetary pinions 50.

The planetary carrier 52 of the second planetary gear reduction mechanism 42 and the planetary carrier 16 of the differential transmission mechanism 10 are connected by a shaft 55. Moreover, the ring gear 48 of the first planetary gear reduction mechanism 41 and the ring gear 54 of the second planetary gear reduction mechanism 42 are fixed. As a result, after the speed of the rotation of the shaft 24′ of the electric motor 8′ is reduced in two stages at a predetermined reduction ratio by the first planetary gear reduction mechanism 41 and the second planetary gear reduction mechanism 42, the rotation at the lowered speed is transmitted to the planetary carrier 16 of the differential transmission mechanism 10.

Similarly to the first embodiment, the offset springs 34 and 35 are provided between the brake pedal PD and the ring gear 14. The controller 38 controls the electric motor 8′ to cause the planetary carrier 16 to rotate according to the amount of operation of the brake pedal PD, that is, the rotational position of the sun gear 11 so that the ring gear 14 follows the rotation of the sun gear 11. In this manner, the same functions and effects as those obtained in the first embodiment are obtained. Moreover, by providing the first planetary gear reduction mechanism 41 and the second planetary gear reduction mechanism 42, the physical size of the electric motor 8′ can be reduced as compared with those of the first and second embodiment. As a result, the electric booster 1′ and the electric assist mechanism 2′ can be reduced in size.

Next, components of the electric booster are described referring to FIG. 11. The components corresponding to the first to third embodiments described above are appropriately described with the same reference symbols. As illustrated in FIG. 11, the electric booster (1) includes: the differential transmission mechanism (10) including the electric motor (8), the first input shaft (11) connected to the brake pedal (PD), the second input shaft (14) to which the electric motor (8) is connected, and the output shaft (16) for outputting the turning force obtained by combining the turning force of the first input shaft (11) and the turning force of the second input shaft (14), the first input shaft (11), the second input shaft (14), and the output shaft (16) making differential motions with respect to each other; and the output mechanism (20, 31) for converting the rotation of the output shaft (16) into the linear movement so as to thrust the piston of the master cylinder (3). Among the above-mentioned components, the differential transmission mechanism (10) including the electric motor (8), the first input shaft (11) connected to the brake pedal (PD), the second input shaft (14) to which the electric motor (8) is connected, and the output shaft (16) for outputting the turning force obtained by combining the turning force of the first input shaft (11) and the turning force of the second input shaft (14), the first input shaft (11), the second input shaft (14), and the output shaft (16) making the differential motions with respect to each other, and the output shaft (16) constitute the electric assist mechanism (2).

Therefore, in the electric booster (1), the reaction force from the piston (P) of the master cylinder (3) is distributed by the differential transmission mechanism (10). Accordingly, it is not necessary to insert the input piston into the pressure chamber of the master cylinder for the distribution of the reaction force, as required in the conventional electric boosters. Hence, the separation of the electric booster (1) from the master cylinder is facilitated. The reduction mechanism (26, 25) may be provided between the second input shaft (14) of the differential transmission mechanism (10) and the electric motor (8). In such a case, the physical size of the electric motor (8) can be reduced. As a result, the electric booster can be reduced in size.

Then, when the brake pedal (PD) is operated, the amount of operation of the brake pedal (amount of rotation of the first input shaft (11)) is detected by the rotational position sensor (15). The driving of the electric motor (8) is controlled by the controller (38) according to the amount of operation (displacement amount) detected by the rotational position sensor (15), that is, according to the amount of rotation of the first input shaft (11). More specifically, the desired braking force (reduction ratio or hydraulic pressure for braking) is calculated based on the amount of operation detected by the rotational position sensor (15). The rotational position of the shaft (24) of the electric motor (8) is subjected to feedback control so as to obtain the calculated braking force. As a result of the control as described above, the operating force of the brake pedal (PD) and the turning force of the electric motor (8) are combined together and output by the differential transmission mechanism (10). Further, the rotation is converted into the linear movement to move the piston of the master cylinder (3) forward to generate the hydraulic pressure. The thus generated hydraulic pressure is supplied to the brake caliper for each wheel to apply the braking force. The control for the electric booster (1) is not limited to the above-mentioned rotational position control for the electric motor (8). As the control for the electric booster (1), a pressure sensor (70) can be provided to the master cylinder (3) so that the controller (38) performs feedback control based on the hydraulic pressure detected by the pressure sensor (70).

As the components of the electric booster (1), the planetary gear mechanism is used as the differential transmission mechanism 10 in which the sun gear 11 serves as the first input shaft, the ring gear 14 as the second input shaft, and the planetary carrier 16 as the output shaft. In addition, the external teeth 26 and the worm gear 25 are used as the reduction mechanism, whereas the pinion portion 20 and the rack portion 31 (rack-pinion mechanism) are used as the rotary-to-linear motion converting mechanism. Moreover, in the second embodiment, the external teeth 26 and the pinion 39 (spur gear) are used as the reduction mechanism.

In the third embodiment described above, the planetary gear mechanism is used as the differential transmission mechanism 10 in which the sun gear 11 serves as the first input shaft, the planetary carrier 16 as the second input shaft, and the ring gear 14 as the output shaft. Moreover, the first planetary gear reduction mechanism 41 and the second planetary gear reduction mechanism 42 are used as the reduction mechanism, whereas the external teeth 26 and the rack portion 31 (rack-pinion mechanism) are used as the rotary-to-linear motion converting mechanism.

In addition, besides the above-mentioned planetary gear mechanism, for example, a ball reduction mechanism, a wave reduction mechanism or the like can be used as the differential transmission mechanism (10). When the ball reduction mechanism is used as the differential transmission mechanism, a boost ratio equal to that of a barometric booster which is generally mounted on existing vehicles, for example, a reduction ratio of 1:7 to 1:8 can be set. Therefore, the electric booster (1) can be mounted to the vehicle without changing the pedal ratio of the brake pedal of the existing vehicles. Besides the worm gear mechanism and the planetary gear mechanism described above, the ball reduction mechanism or the wave reduction mechanism can be used as the reduction mechanism (26, 25). Alternatively, the reduction mechanism (26, 25) may be omitted, and the second input shaft (14) of the differential transmission mechanism (10) may be directly driven by the electric motor (8). Moreover, besides the rack-pinion mechanism described above, a ball screw mechanism, a screw mechanism, a link mechanism, or the like can be used as the output mechanism (20, 31) corresponding to the rotary-to-linear motion converting mechanism.

An electric booster according to each embodiment includes: an electric motor; a differential transmission mechanism including: a first input shaft connected to a brake pedal; a second input shaft to which the electric motor is connected; and an output shaft for outputting a turning force obtained by combining a turning force of the first input shaft and a turning force of the second input shaft, the first input shaft, the second input shaft, and the output shaft making differential motions with respect to each other; and an output mechanism for converting rotation of the output shaft into linear movement to thrust a piston of a master cylinder. With the configuration described above, the reaction force from the piston of the master cylinder is distributed by the differential transmission mechanism. Therefore, it is not necessary to insert the input piston into the pressure chamber of the master cylinder for the distribution of the reaction force, as required in the conventional electric boosters. As a result, the structural separation of the electric booster from the master cylinder is facilitated. Accordingly, the fabrication efficiency is improved because the electric booster and the master cylinder can be assembled separately. Moreover, the brake fluid in the master cylinder is not required to be drained for the maintenance of the electric booster, to thereby provide the ease of maintenance. Further, various types of brake control can be performed because the output displacement amount can be varied with respect to the input displacement amount.

According to each embodiment, the turning force of the second input shaft is larger in ratio than the turning force of the first input shaft in the differential transmission mechanism. With the configuration described above, the part of the reaction force, which is distributed to the brake pedal, is reduced with respect to the entire reaction force from the piston of the master cylinder. Thus, the electric booster which can realize a preferred boost ratio can be provided.

According to each embodiment, the differential transmission mechanism serves as a planetary gear mechanism. With the configuration described above, the electric booster can be fabricated to have a relatively simple structure. As a result, the fabrication efficiency is improved.

According to each embodiment, a ratio of the turning force of the first input shaft and the turning force of the second input shaft of the differential transmission mechanism is (planetary gear mechanism) 1:3 to 1:4.

According to each embodiment, centers of rotation of the first input shaft, the second input shaft, and the output shaft are concentrically located. With the configuration described above, the relatively compact differential transmission mechanism can be used. As a result, the electric booster can be reduced in size.

According to each embodiment, rotation of the electric motor is controlled so that an amount of rotation of the second input shaft becomes equal to an amount of rotation of the first input shaft.

According to each embodiment, urging means is provided between the first input shaft and one of the second input shaft and the output shaft, the urging means elastically urging the first input shaft and the one of the second input shaft and the output shaft to place relative rotational positions of the first input shaft and the one of the second input shaft and the output shaft. With the configuration describe above, even when the input/output displacement characteristic of the electric booster is changed, the reaction force against the operation of the brake pedal is adjusted by the urging means. As a result, the input/output characteristic of the electric booster remains unchanged. Therefore, the input/output displacement characteristic is changed to achieve the brake control such as the brake assist control, the regenerative cooperative control, and the build-up control, which is performed by the electric booster, without bothering the driver with an uncomfortable feeling due to the reaction force to the brake pedal.

According to each embodiment, the urging means is provided between the first input shaft and the one of the second input shaft and the output shaft, and the urging means includes: first spring means for urging the first input shaft and the one of the second input shaft and the output shaft so that the first input shaft and the one of the second input shaft and the output shaft rotate relative to each other in one direction; and second spring means for urging the first input shaft and the one of the second input shaft and the output shaft so that the first input shaft and the one of the second input shaft and the output shaft rotate relative to each other in an opposite direction.

According to each embodiment, a reduction mechanism is provided between the second input shaft and the electric motor. The reduction mechanism prevents the electric motor from being increased in size, and consequently, allows the electric booster to be reduced in size.

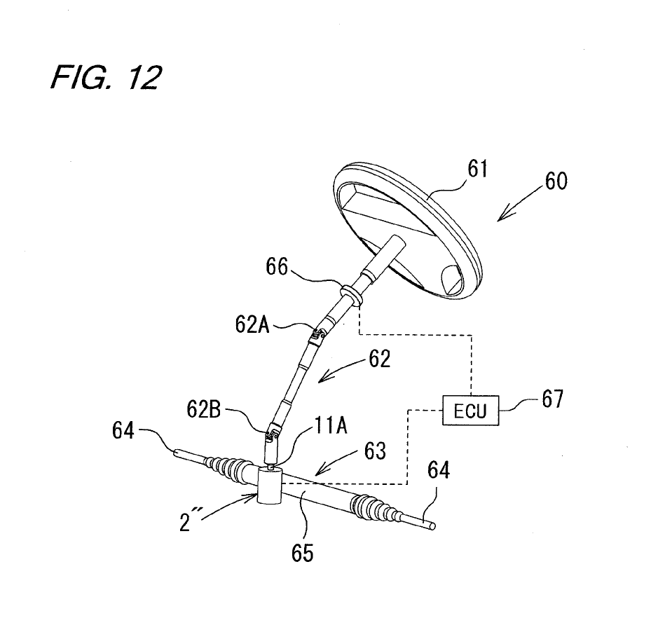

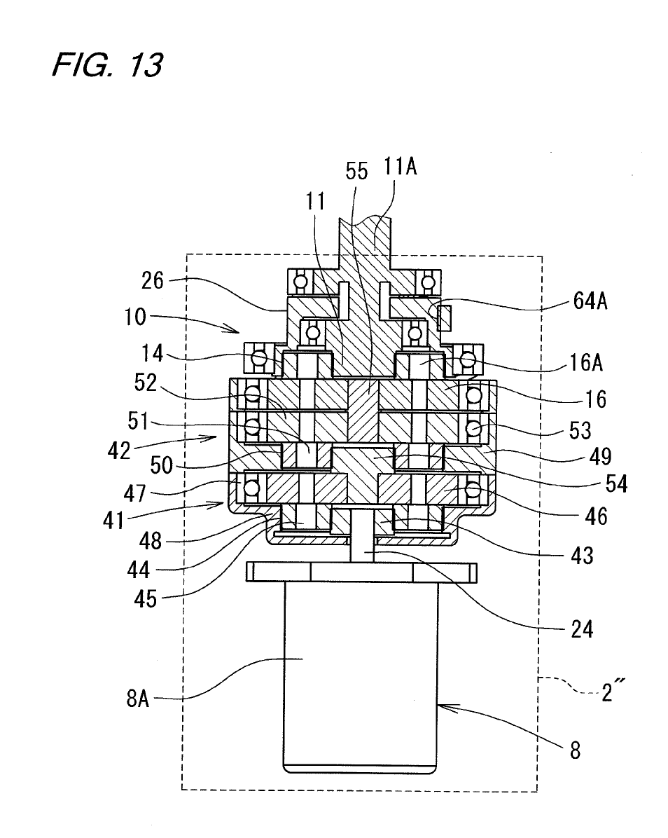

The electric assist mechanism 2′ described above in the third embodiment is applicable other than to the brake system. For example, a reference technology employed in the case where an electric assist mechanism 2″ is mounted to an electric power steering device for automobile is described referring to FIGS. 12 and 13. The parts corresponding to the electric assist mechanism 2′ in the third embodiment described above are denoted by the same reference symbols, and only different parts are described in detail.

As illustrated in FIG. 12, an electric power steering device 60 is used to steer wheels to be steered (in general, front wheels) of an automobile. The electric power steering device 60 transmits the rotation of a steering wheel 61 to a steering gear device 63 through an intermediation of a steering column shaft 62 (input member) including universal joints 62A and 628 so as to convert the rotation into the movement of a steering rack 64 in a horizontal direction of a vehicle body. In this manner, knuckles of suspension systems are turned through tie rods (not shown) respectively connected to both ends of the steering rack 64 to steer the wheels supported by the knuckles.

Inside a steering gear case 65, the external teeth 26 of the ring gear 14 of the electric booster 1′ are meshed with a rack portion 64A of the steering rack 64 (output member) which is supported so as to be movable in the horizontal direction of the vehicle body. In this manner, a steering gear device 63 moves the steering rack 64 in the horizontal direction of the vehicle body by the rotation of the ring gear 14. A distal end portion of a steering column shaft 62 is connected to the shaft portion 11A of the sun gear 11 of the electric booster 1″.

In this manner, for the rotation of the steering wheel 61, the electric motor 8 is controlled so that the ring gear 14 follows the rotation of the sun gear 11. A servo force at a constant ratio (reduction ratio of the steering gear device 63) generated by the electric motor 8 can be provided to the movement of the steering rack 64. Moreover, the amount of operation of the steering wheel 61 is detected by a rotational position sensor 66. For the detected amount of operation, an ECU 67 controls the electric motor 8. As a result, the amount of rotation of the ring gear 14 can be varied. Therefore, by reducing or increasing the amount of rotation of the ring gear 14 according to the amount of operation of the steering wheel 61, variable displacement amount control can be performed for the steering rack 64. As a result, the amount of operation of the steering wheel 61 can be adjusted according to a running state of the vehicle.

As the electric power steering device, there exists an electric power steering device having a transmission ratio variable mechanism for varying the amount of movement of the steering rack with respect to the amount of operation of the steering wheel as described in Japanese Patent Application Laid-open No. 2005-112025. In the electric power steering device having the transmission ratio variable mechanism, however, two electric motors, that is, an electric motor for varying a transmission ratio and an electric motor for steering assist are provided. Therefore, the above-mentioned electric power steering device has problems in a complicated structure and low production efficiency. By using the electric assist mechanism 2″ for the electric power steering device 60 as in the present reference technology, the amount of rotation of the ring gear 14, that is, a steering angle can be varied with respect to the amount of operation of the steering wheel 61 with a single electric motor. Thus, the effects of simplifying the structure and improving the production efficiency can be obtained.

Each of the electric assist mechanisms 2 and 2′ described above can be used not only for the electric power steering device as described above but also for a device for electrically assisting a human operating force, for example, for an electrically-assisted bicycle or the like.

According to the above-mentioned electric booster of each embodiment of the present invention, the structural separation of the electric booster from the master cylinder is facilitated.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2009-250929 filed on Oct. 30, 2009. The entire disclosure of Japanese Patent Application No. 2009-250929 filed on Oct. 30, 2009 including specification, claims, drawings and summary is incorporated herein by reference in its entirety.

The entire disclosure of Japanese Laid Open Publication No. 2005-112025 including specification, claims, drawings and summary is incorporated herein by reference in its entirety.

What is claimed is:

1. An electric booster, comprising:
an electric motor;
a differential transmission mechanism including: a first input shaft connected to a brake pedal; a second input shaft to which the electric motor is connected; and an output shaft for outputting a turning force obtained by combining a turning force of the first input shaft and a turning force of the second input shaft, the first input shaft, the second input shaft, and the output shaft making differential motions with respect to each other; and
an output mechanism for converting rotation of the output shaft into linear movement to thrust a piston of a master cylinder.

2. An electric booster according to claim 1, wherein the turning force of the second input shaft is larger in ratio than the turning force of the first input shaft in the differential transmission mechanism.

3. An electric booster according to claim 2, wherein the differential transmission mechanism serves as a planetary gear mechanism.

4. An electric booster according to claim 3, wherein a ratio of the turning force of the first input shaft of the differential transmission mechanism and the turning force of the second input shaft of the differential transmission mechanism is 1:3 to 1:4.

5. An electric booster according to claim 1, wherein centers of rotation of the first input shaft, the second input shaft, and the output shaft are concentrically located.

6. An electric booster according to claim 1, wherein rotation of the electric motor is controlled so that an amount of rotation of the second input shaft becomes equal to an amount of rotation of the first input shaft.

7. An electric booster according to claim 1, further comprising urging means provided between the first input shaft and one of the second input shaft and the output shaft, the urging means elastically urging the first input shaft and the one of the second input shaft and the output shaft to place relative rotational positions of the first input shaft and one of the second input shaft and the output shaft in neutral positions.

8. An electric booster according to claim 7, wherein the urging means is provided between the first input shaft and the one of the second input shaft and the output shaft, and
the urging means includes:
first spring means for urging the first input shaft and the one of the second input shaft and the output shaft so that the first input shaft and the one of the second input shaft and the output shaft rotate relative to each other in one direction; and
second spring means for urging the first input shaft and the one of the second input shaft and the output shaft so that the first input shaft and the one of the second input shaft and the output shaft rotate relative to each other in an opposite direction.

9. An electric booster according to claim 1, further comprising a reduction mechanism provided between the second input shaft and the electric motor.

10. An electric booster, comprising:
an output member for moving linearly so as to push a piston of a master cylinder;
a reduction mechanism including:
a first input shaft having one end rotating upon reception of a turning force generated by an operation of a brake pedal and another end including a sun gear;
a second input shaft including a planetary gear revolving upon reception of a turning force of the first input shaft, the planetary gear having an axis of revolution coaxial with the first input shaft; and
an output shaft including an internal gear rotating upon reception of a turning force obtained by combining a turning force of the sun gear and a turning force of the planetary gear, the output shaft being coaxial with an axis of the first input shaft and the axis of revolution of the second input shaft;
an electric motor for applying the turning force to the second input shaft of the reduction mechanism; and
a rotary-to-linear motion converting mechanism for converting turning movement of the output shaft into linear movement and transmitting the linear movement to the output member.

11. An electric booster according to claim 10, wherein rotation of the electric motor is controlled so that an amount of rotation of the second input shaft becomes equal to an amount of rotation of the first input shaft.

12. An electric booster according to claim 10, further comprising at least one of first spring means and second spring means provided between the first input shaft and one of the second input shaft and the output shaft,
the first spring means urging the first input shaft and the one of the second input shaft and the output shaft so that the first input shaft and the one of the second input shaft and the output shaft rotate relative to each other in one direction,
the second spring means urging the first input shaft and the one of the second input shaft and the output shaft so that the first input shaft and the one of the second input shaft and the output shaft rotate relative to each other in an opposite direction.

13. An electric booster according to claim 10, further comprising a reduction mechanism provided between the second input shaft and the electric motor.

14. An electric booster according to claim 13, wherein the reduction mechanism includes a worm and a wheel.

15. An electric booster according to claim 13, wherein the reduction mechanism serves as a gear speed reducer.

16. An operating force transmission device, comprising:
an input member including a rotary shaft operated to generate a turning force;
an output member moving linearly upon reception of the turning force so as to operate a member to be operated;
a transmission mechanism including:
a first input shaft rotating upon reception of the turning force of the rotary shaft of the input member;
a second input shaft rotating upon reception of the turning force, the second input shaft being coaxial with the first input shaft; and
an output shaft for applying a turning force obtained by combining the turning force of the first input shaft and the turning force of the second input shaft to the output member upon reception of the turning force obtained by the combination, the output shaft being coaxial with the first input shaft and the second input shaft; and
an electric motor for applying the turning force to the second input shaft of the transmission mechanism.

17. An operating force transmission device according to claim 16, wherein the input member serves as a brake pedal, and the member to be operated serves as a piston of a master cylinder.

18. An operating force transmission device according to claim 16, wherein the input member serves as a steering column, and the member to be operated serves as a steering rack.
